(19) United States
(12) Patent Application Publication
(10) Pub. No.: US 2012/0131402 A1
(43) Pub. Date: May 24, 2012

(54) TEST MODE SETTING CIRCUIT

(76) Inventors: Masakazu SUGIURA, Chiba-shi (JP); Atsushi IGARASHI, Chiba-shi (JP)

(21) Appl. No.: 13/289,548

(22) Filed: Nov. 4, 2011

(30) Foreign Application Priority Data
Nov. 24, 2010 (JP) 2010-261719

(51) Int. Cl. G06F 11/267

(52) U.S. Cl. 714/726; 714/E11.162

(57) ABSTRACT

Provided is a test mode setting circuit with a smaller number of terminals. A detector having a low threshold voltage and a detector having a high threshold voltage are provided to a test terminal for controlling a test mode of a semiconductor device, and the detector having the low threshold voltage releases a reset of a logic circuit while the detector having the high threshold voltage controls switching of the test mode. This configuration uses the test terminal, a reset terminal, and test mode control terminals in common between a normal state and a test state, thus reducing a large number of the terminals.

### RELATED APPLICATIONS

This application claims priority under 35 U.S.C. §119 to Japanese Patent Application No. 2010-261719 filed on Nov. 24, 2010, the entire content of which is hereby incorporated by reference.

### BACKGROUND OF THE INVENTION

1. Field of the Invention

The present invention relates to a test mode setting circuit for setting a plurality of modes in a test mode of a semiconductor device.

2. Description of the Related Art

A conventional test mode setting circuit is described. FIG. 9 is a diagram illustrating the conventional test mode setting circuit. Terminals of the test mode setting circuit are used in a normal state, except for a test terminal to which a test signal TEST is input.

When the test signal TEST is controlled to High, the semiconductor device shifts from a normal mode to a test mode. After that, input signals INPUT1 to INPUT3 are input to latches 31 to 33, respectively. The input signals INPUT1 to INPUT3 are signals for setting a plurality of modes in the test mode. Here, when a reset signal RESET becomes High, a reset of each of the latches 31 to 33 is released, and the latches 31 to 33 perform a latch operation. In other words, the latches 31 to 33 latch and output the input signals INPUT1 to INPUT3, respectively. Based on the 3-bit output signals of the latches 31 to 33, a decoder 34 outputs 7-bit test mode signals TM1 to TM7. Note that, when all the output signals of the latches 31 to 33 are Low, all the test mode signals TM1 to TM7 are also controlled to Low (see, for example, Japanese Patent Application Laid-open No. 2003-185706).

As described above, the conventional test mode setting circuit uses the reset terminal and the input terminals in common between the normal state and the test state. Thus, no terminals dedicated for test are required, and hence manufacturing cost can be reduced.

The conventional test mode setting circuit, however, needs the test terminal, the reset terminal, and the plurality of input terminals in order to set the test mode. Some semiconductor devices do not require so many terminals in the normal state. An example of the semiconductor devices is the one having four terminals, namely power supply terminals, an input terminal, and an output terminal. In this kind of semiconductor device, the number of terminals is short for the conventional test mode setting circuit, and an additional terminal is needed for setting the test mode.

### SUMMARY OF THE INVENTION

The present invention has been made in view of the above-mentioned problem, and provides a test mode setting circuit with a smaller number of terminals.

In order to solve the above-mentioned problem, the present invention provides a test mode setting circuit for controlling a test mode of a semiconductor device, including: a first detector having a first threshold voltage and including an input terminal connected to a test terminal; a second detector having a second threshold voltage and including an input terminal connected to the test terminal; and a logic circuit including a first input terminal connected to an output terminal of the first detector and a second input terminal connected to an output terminal of the second detector, for controlling the test mode of the semiconductor device based on output signals of the first detector and the second detector, in which a reset of the logic circuit is released when a voltage of the test terminal changes from a first power supply voltage to exceed the first threshold voltage of the first detector, to thereby set the semiconductor device to the test mode, and in the test mode of the semiconductor device, when the voltage of the test terminal exceeds the second threshold voltage of the second detector, the logic circuit controls switching of a mode setting of the test mode.

According to the test mode setting circuit of the present invention, the detector having the low threshold voltage and the detector having the high threshold voltage are provided to the test terminal for controlling the test mode of the semiconductor device, and the detector having the low threshold voltage releases the reset of the logic circuit while the detector having the high threshold voltage controls switching of the test mode. This configuration uses the test terminal, a reset terminal, and test mode control terminals in common between a normal state and a test state, thus reducing a large number of the terminals.

### BRIEF DESCRIPTION OF THE DRAWINGS

In the accompanying drawings:

FIG. 1 is a circuit diagram illustrating a test mode setting circuit according to a first embodiment of the present invention;

FIG. 2 is a time chart illustrating voltages at respective nodes of the test mode setting circuit according to the first embodiment;

FIG. 3 is a circuit diagram illustrating a test mode setting circuit according to a second embodiment of the present invention;

FIG. 4 is a time chart illustrating voltages at respective nodes of the test mode setting circuit according to the second embodiment;

FIG. 5 is a circuit diagram illustrating a test mode setting circuit according to a third embodiment of the present invention;

FIG. 6 is a time chart illustrating voltages at respective nodes of the test mode setting circuit according to the third embodiment;

FIG. 7 is a circuit diagram illustrating a test mode setting circuit according to a fourth embodiment of the present invention;

FIG. 8 is a time chart illustrating voltages at respective nodes of the test mode setting circuit according to the fourth embodiment; and

FIG. 9 is a circuit diagram illustrating a conventional test mode setting circuit.

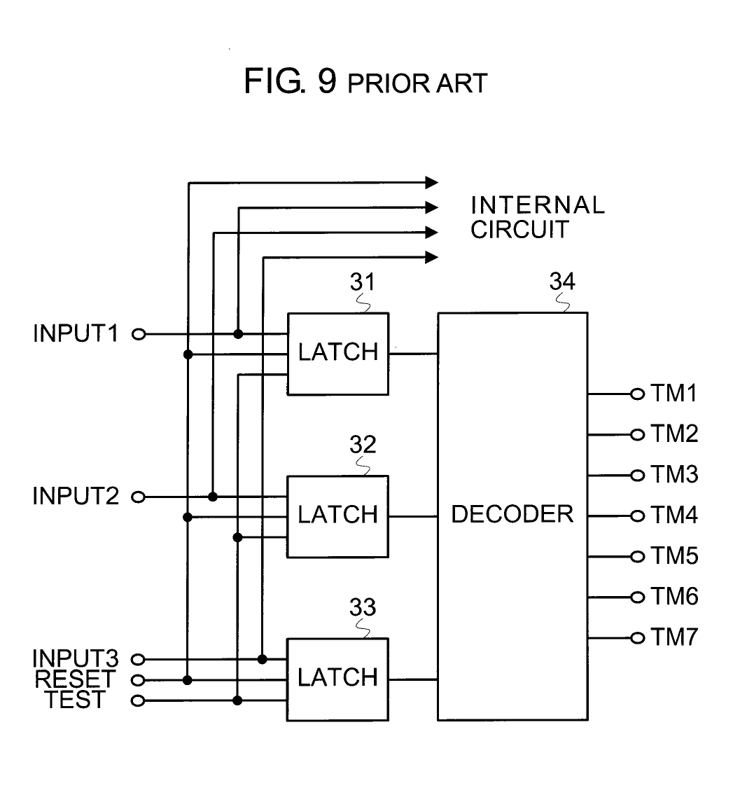

### DETAILED DESCRIPTION OF THE PREFERRED EMBODIMENTS

Referring to the accompanying drawings, embodiments of the present invention are described below.

### First Embodiment

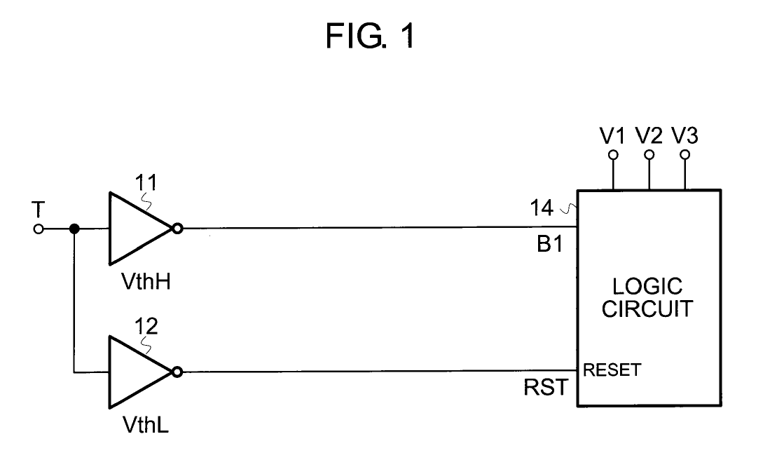

FIG. 1 is a circuit diagram illustrating a test mode setting circuit according to a first embodiment of the present invention.

The test mode setting circuit according to the first embodiment includes a high threshold inverter 11, a low threshold inverter 12, a logic circuit 14, a test terminal, and first to third output terminals.

The high threshold inverter 11 has an input terminal connected to the test terminal of the test mode setting circuit, and an output terminal connected to a first input terminal of the logic circuit 14. The low threshold inverter 12 has an input terminal connected to the test terminal of the test mode setting circuit, and an output terminal connected to a reset terminal of the logic circuit 14. The logic circuit 14 has first to third output terminals connected to the first to third output terminals of the test mode setting circuit, respectively.

Here, when a semiconductor device operates in a normal mode, a test signal T supplied to the test terminal is controlled to a voltage lower than a low threshold voltage VthL. When the semiconductor device performs mode setting in a test mode, the amplitude of the test signal T is controlled between a power supply voltage VDD and a voltage between a high threshold voltage VthH and the low threshold voltage VthL. The high threshold inverter 11 has the high threshold voltage VthH. The low threshold inverter 12 has the low threshold voltage VthL that is lower than the high threshold voltage VthH. The logic circuit 14 sets the mode of the semiconductor device based on a signal B1 and a reset signal RST.

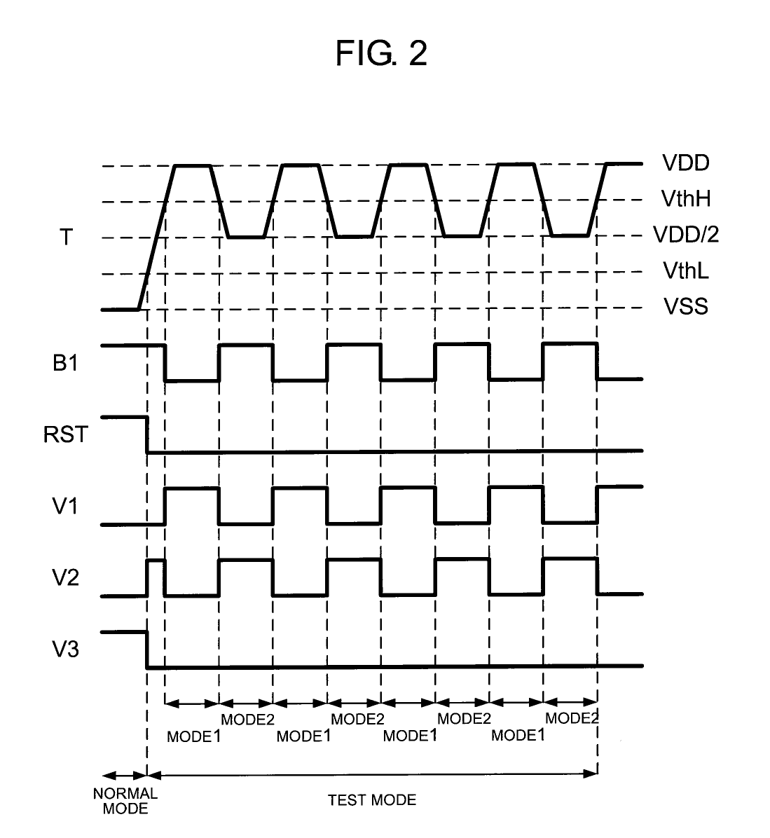

Next, an operation of the test mode setting circuit is described. FIG. 2 is a time chart illustrating voltages at respective nodes of the test mode setting circuit according to the first embodiment.

In the time chart, a signal of High is represented by “1” and a signal of Low is represented by “0”.

The test signal T is input to the test terminal of the test mode setting circuit. When the semiconductor device operates in the normal mode, the test signal T is controlled to a voltage lower than the low threshold voltage VthL of the low threshold inverter 12. When the semiconductor device operates in the test mode, the test signal T is controlled to have the amplitude between the power supply voltage VDD and an intermediate voltage (VDD/2).

### [Operation in Normal Mode]

The test signal T is controlled to a voltage lower than the low threshold voltage VthL. Accordingly, the high threshold inverter 11 sets the signal B1 to High and the low threshold inverter 12 sets the reset signal RST also to High. On this occasion, if (reset signal RST)=(“1”), the logic circuit 14 operates so that (signal V1, signal V2, signal V3)=(“0”, “0”, “1”) may be satisfied. Based on the signals V1 and V2 of Low and the signal V3 of High, the semiconductor device operates in the normal mode.

### [Operation in Test Mode]

If the test signal T becomes higher than the low threshold voltage VthL, the reset signal RST falls and the semiconductor device shifts from the normal mode to the test mode. If the test signal T becomes higher than the high threshold voltage VthH of the high threshold inverter 11, the signal B1 becomes Low. If the test signal T becomes lower than the high threshold voltage VthH, the signal B1 becomes High. On this occasion, if (signal B1, reset signal RST)=(“0”, “0”), the logic circuit 14 operates so that (signal V1, signal V2, signal V3)=(“1”, “0”, “0”) may be satisfied. Based on the signal V1 of High and the signals V2 and V3 of Low, the semiconductor device is set to operate in the test mode of Mode 1. At this time, for example, a voltage of an external connection terminal of the semiconductor device is tested.

If (signal B1, reset signal RST)=(“1”, “0”), the logic circuit 14 operates so that (signal V1, signal V2, signal V3)=(“0”, “1”, “0”) may be satisfied. Based on the signal V1 of Low, the signal V2 of High, and the signal V3 of Low, the semiconductor device is set to operate in the test mode of Mode 2.

In the operation in the test mode, Modes 1 and 2 are repeatedly set alternately. For example, it is supposed that the semiconductor device is a detector IC for comparing an application voltage applied from the outside and a set voltage, and inverting an output voltage based on the result of comparison. Here, the set voltage is controlled to gradually increase so as to be equal to the application voltage in Mode 1 for the third time in the test mode. In this case, if the output voltage of the detector IC is inverted, the operation of the detector IC is determined to be normal.

According to the test mode setting circuit of the first embodiment described above, when the semiconductor device operates in the normal mode, the test signal T supplied to the test terminal is controlled to a voltage lower than the low threshold voltage VthL, and the test signal T is used as a reset signal, thus eliminating the need of a reset terminal for inputting a reset signal.

On the other hand, when the semiconductor device operates in the test mode, the test mode can be set by controlling the test signal T around the high threshold voltage VthH, thus eliminating the need of an input terminal for setting a mode as well.

Note that, the logic of High and Low in each signal is designed as appropriate. For example, when the semiconductor device operates in the normal mode, the test signal T may be controlled to a voltage higher than the high threshold voltage VthH of the high threshold inverter 11, and when the semiconductor device operates in the test mode, the test signal T may be controlled to have the amplitude between a ground voltage VSS and the intermediate voltage (VDD/2).

In the above description, the lower limit of the amplitude of the test signal T in the test mode is the intermediate voltage (VDD/2), but may be any voltage between the high threshold voltage VthH and the low threshold voltage VthL.

In the above description, the high threshold inverter 11 and the low threshold inverter 12 are used to the test terminal, but the present invention is not limited thereto. Any high threshold detector having a high threshold voltage and any low threshold detector having a low threshold voltage can be used. For example, those may each be formed by a reference voltage circuit for setting a threshold voltage and a comparator. In other words, the high threshold inverter 11 is an example of the high threshold detector and the low threshold inverter 12 is an example of the low threshold detector.

### Second Embodiment

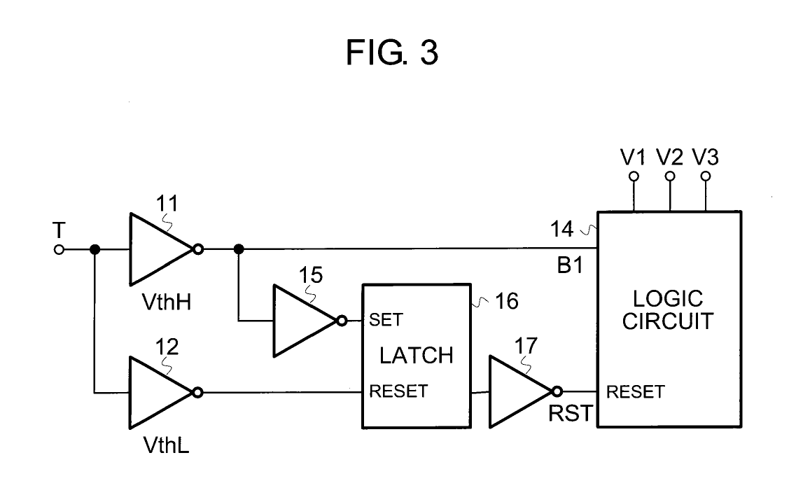

FIG. 3 is a circuit diagram illustrating a test mode setting circuit according to a second embodiment of the present invention.

The test mode setting circuit according to the second embodiment includes a high threshold inverter 11, a low threshold inverter 12, a logic circuit 14, an inverter 15, a latch 16, an inverter 17, a test terminal, and first to third output terminals.

The inverter 15 has an input terminal connected to an output terminal of the high threshold inverter 11. The latch 16 has a set terminal connected to an output terminal of the inverter 15, a reset terminal connected to an output terminal of the low threshold inverter 12, and an output terminal connected to an input terminal of the inverter 17. The inverter 17 has an output terminal connected to a reset terminal of the logic circuit 14.

Here, if the test signal T becomes higher than the low threshold voltage VthL, a reset of the latch 16 is released. After that, if the test signal T becomes higher than the high threshold voltage VthH, the latch 16 is set to shift the semiconductor device to the test mode.

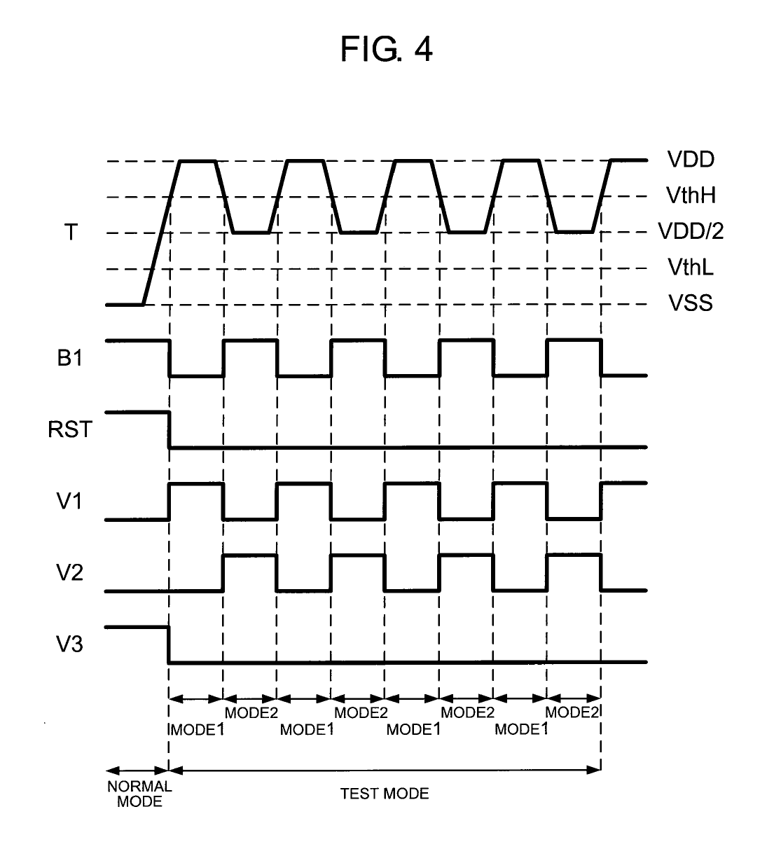

Next, an operation of the test mode setting circuit is described. FIG. 4 is a time chart illustrating respective voltages.

In the first embodiment, the timing when the reset signal RST falls is the timing when the test signal T becomes higher than the low threshold voltage VthL. In the second embodiment, on the other hand, the timing is the timing when the test signal T becomes higher than the high threshold voltage VthH. In other words, if the test signal T becomes higher than the high threshold voltage VthH, the reset signal RST falls and the semiconductor device shifts from the normal mode to the test mode. Specifically, if the test signal T becomes higher than the low threshold voltage VthL, the output signal of the low threshold inverter 12 becomes Low to release the reset of the latch 16. After that, if the test signal T becomes higher than the high threshold voltage VthH, the output signal of the high threshold inverter 11 becomes Low and the output signal of the inverter 15 becomes High to set the latch 16. Accordingly, the output signal of the latch 16 becomes High and the reset signal RST becomes Low.

On this occasion, if (reset signal RST)=(“1”), similarly to the first embodiment, the logic circuit 14 operates so that (signal V1, signal V2, signal V3)=(“0”, “0”, “1”) may be satisfied. Accordingly, the waveforms of the signals V1 to V3 are changed because of the change of the falling timing of the reset signal RST.

According to the test mode setting circuit of the second embodiment described above, if the test signal T becomes higher than the high threshold voltage VthH, rather than the low threshold voltage VthL, the reset signal RST falls and the semiconductor device shifts from the normal mode to the test mode. Because the high threshold voltage VthH is higher than the low threshold voltage VthL, the semiconductor device is less liable to shift to the test mode. Accordingly, the semiconductor device is less liable to shift to the test mode incorrectly because of noise to the test signal T or the like, and hence the semiconductor device is less liable to malfunction.

### Third Embodiment

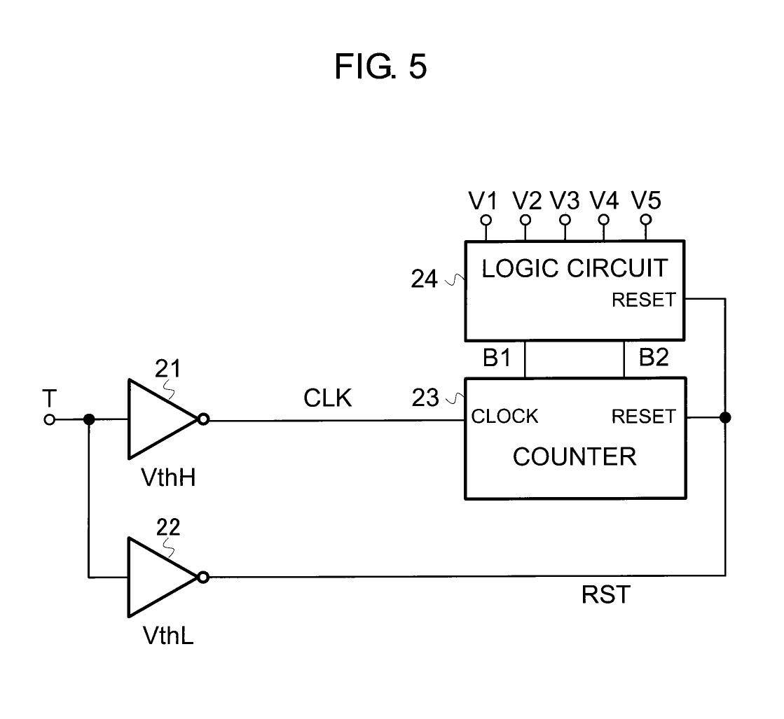

FIG. 5 is a circuit diagram illustrating a test mode setting circuit according to a third embodiment of the present invention.

The test mode setting circuit according to the third embodiment includes a high threshold inverter 21, a low threshold inverter 22, a counter 23, and a logic circuit 24.

The high threshold inverter 21 has an input terminal connected to a test terminal of the test mode setting circuit, and an output terminal connected to a clock terminal of the counter 23. The low threshold inverter 22 has an input terminal connected to the test terminal of the test mode setting circuit, and an output terminal connected to reset terminals of the counter 23 and the logic circuit 24. The logic circuit 24 has first and second input terminals connected to first and second output terminals of the counter 23, respectively, and first to fifth output terminals connected to first to fifth output terminals of the test mode setting circuit, respectively.

Here, when a semiconductor device operates in a normal mode, a test signal T supplied to the test terminal is controlled to a voltage lower than a low threshold voltage VthL. When the semiconductor device operates in a test mode, the amplitude of the test signal T is controlled between a power supply voltage VDD and an intermediate voltage (VDD/2). The high threshold inverter 21 has a high threshold voltage VthH. The low threshold inverter 22 has the low threshold voltage VthL that is lower than the high threshold voltage VthH. The counter 23 counts a clock signal CLK supplied to the clock terminal. The logic circuit 24 sets the mode of the semiconductor device based on a reset signal RST and signals B1 and B2.

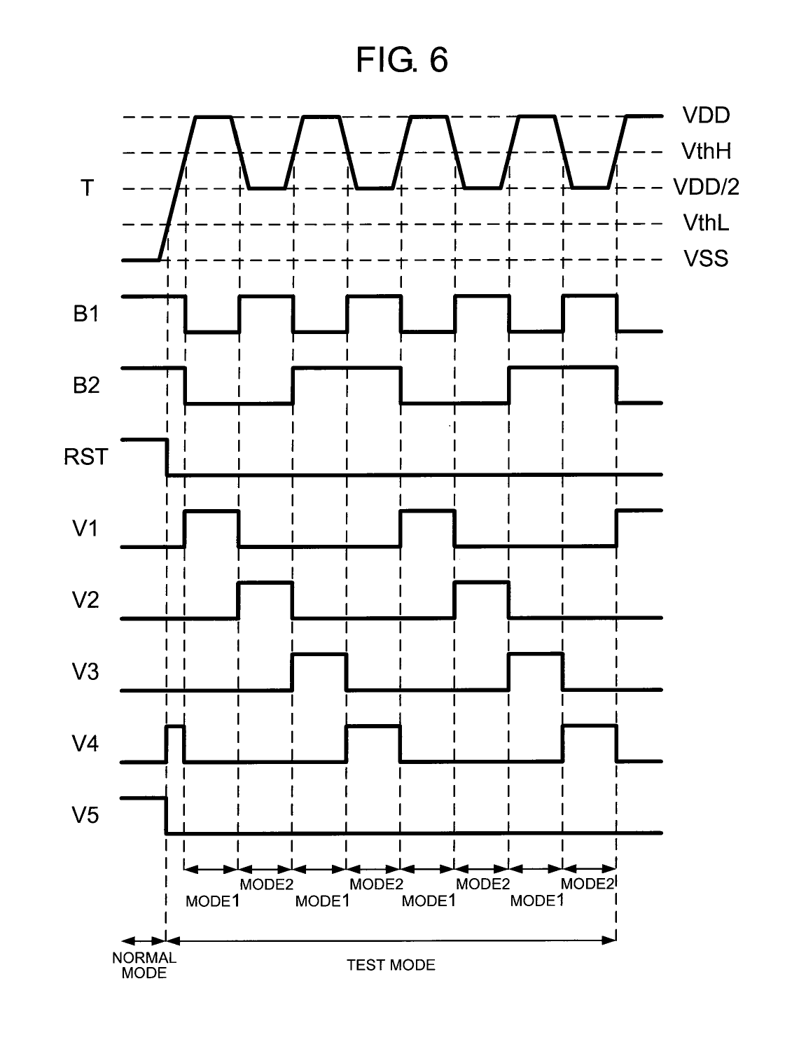

Next, an operation of the test mode setting circuit is described. FIG. 6 is a time chart illustrating voltages at respective nodes of the test mode setting circuit according to the third embodiment.

### [Operation in Normal Mode]

The test signal T is controlled to a voltage lower than the low threshold voltage VthL. Accordingly, the high threshold inverter 21 sets the clock signal CLK to High and the low threshold inverter 22 sets the reset signal RST also to High. On this occasion, if (reset signal RST)=(“1”), the counter 23 operates so that (signal B1, signal B2)=(“1”, “1”) may be satisfied. Further, the logic circuit 24 operates so that (signal V1, signal V2, signal V3, signal V4, signal V5)=(“0”, “0”, “0”, “0”, “1”) may be satisfied. Based on the signals V1 to V4 of Low and the signal V5 of High, the semiconductor device operates in the normal mode.

### [Operation in Test Mode]

If the test signal T becomes higher than the low threshold voltage VthL, the reset signal RST falls and the semiconductor device shifts from the normal mode to the test mode. If the test signal T becomes higher than the high threshold voltage VthH of the high threshold inverter 11, the clock signal CLK becomes Low. If the test signal T becomes lower than the high threshold voltage VthH, the clock signal CLK becomes High. The counter 23 outputs the clock signal CLK directly as the signal B1. The counter 23 also divides the frequency of the clock signal CLK and outputs the resultant as the signal B2. On this occasion, if (signal B2, signal B1, reset signal RST)=(“0”, “0”, “0”), the logic circuit 24 operates so that (signal V1, signal V2, signal V3, signal V4, signal V5)=(“1”, “0”, “0”, “0”, “0”) may be satisfied. Based on the signal V1 of High and the signals V2 to V5 of Low, the semiconductor device is set to operate in the test mode of Mode 1. At this time, for example, a voltage of an external connection terminal of the semiconductor device is tested, whereby the semiconductor device in the test mode of Mode 1 is tested.

If (signal B2, signal B1, reset signal RST)=(“0”, “1”, “0”), the logic circuit 24 operates so that (signal V1, signal V2, signal V3, signal V4, signal V5)=(“0”, “1”, “0”, “0”, “0”) may be satisfied. Based on the signal V1 of Low, the signal V2 of High, and the signals V3 to V5 of Low, the semiconductor device is set to operate in the test mode of Mode 2.

If (signal B2, signal B1, reset signal RST)=(“1”, “0”, “0”), the logic circuit 24 operates so that (signal V1, signal V2, signal V3, signal V4, signal V5)=(“0”, “0”, “1”, “0”, “0”) may be satisfied. Based on the signals V1 and V2 of Low, the signal V3 of High, and the signals V4 and V5 of Low, the semiconductor device is set to operate in the test mode of Mode 3.

If (signal B2, signal B1, reset signal RST)=(“1”, “1”, “0”), the logic circuit 24 operates so that (signal V1, signal V2, signal V3, signal V4, signal V5)=(“0”, “0”, “0”, “1”, “0”) may be satisfied. Based on the signals V1 to V3 of Low, the signal V4 of High, and the signal V5 of Low, the semiconductor device is set to operate in the test mode of Mode 4.

With the configuration described above, in the test mode, three or more modes can be set in the third embodiment, though two modes are set in the first and second embodiments.

Note that, in FIG. 5, 2 bits of the signals B1 and B2 for controlling the logic circuit 24 are prepared so that four modes are prepared in the test mode. Although not illustrated, alternatively, 3 bits of signals for controlling the logic circuit 24 may be prepared so that eight modes are prepared in the test mode.

Further, in FIG. 6, the four modes in the test mode are prepared by the signal B1 and the signal B2 that is generated by dividing the frequency of the signal B1. In this case, one mode in the test mode is set at a half cycle of the signal B1. Although not illustrated, alternatively, the four modes in the test mode may be prepared by the signal B2 and a signal B3 that is generated by dividing the frequency of the signal B2. In this case, one mode in the test mode is set at a half cycle of the signal B2, that is, one cycle of the signal B1. This configuration allows the test signal T to be the power supply voltage VDD in each mode of the test mode. Therefore, the semiconductor device can be tested when the test signal T becomes the power supply voltage VDD, rather than the intermediate voltage (VDD/2). Thus, stable test is carried out.

### Fourth Embodiment

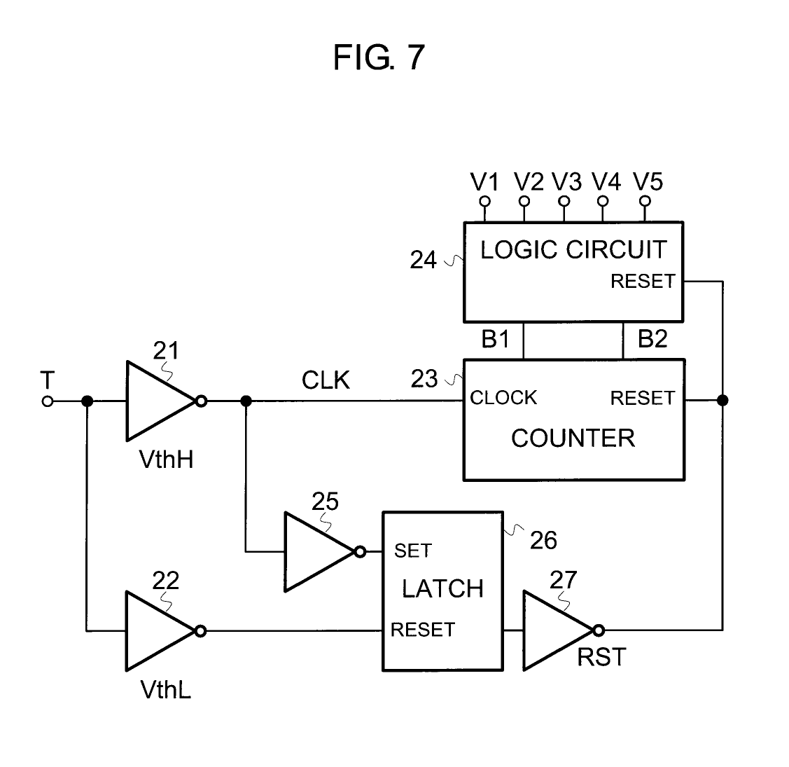

FIG. 7 is a circuit diagram illustrating a test mode setting circuit according to a fourth embodiment of the present invention.

The test mode setting circuit according to the fourth embodiment is configured by adding an inverter 25, a latch 26, and an inverter 27 to the test mode setting circuit according to the third embodiment.

The inverter 25 has an input terminal connected to an output terminal of the high threshold inverter 21. The latch 26 has a set terminal connected to an output terminal of the inverter 25, a reset terminal connected to an output terminal of the low threshold inverter 22, and an output terminal connected to an input terminal of the inverter 27. The inverter 27 has an output terminal connected to reset terminals of the counter 23 and the logic circuit 24.

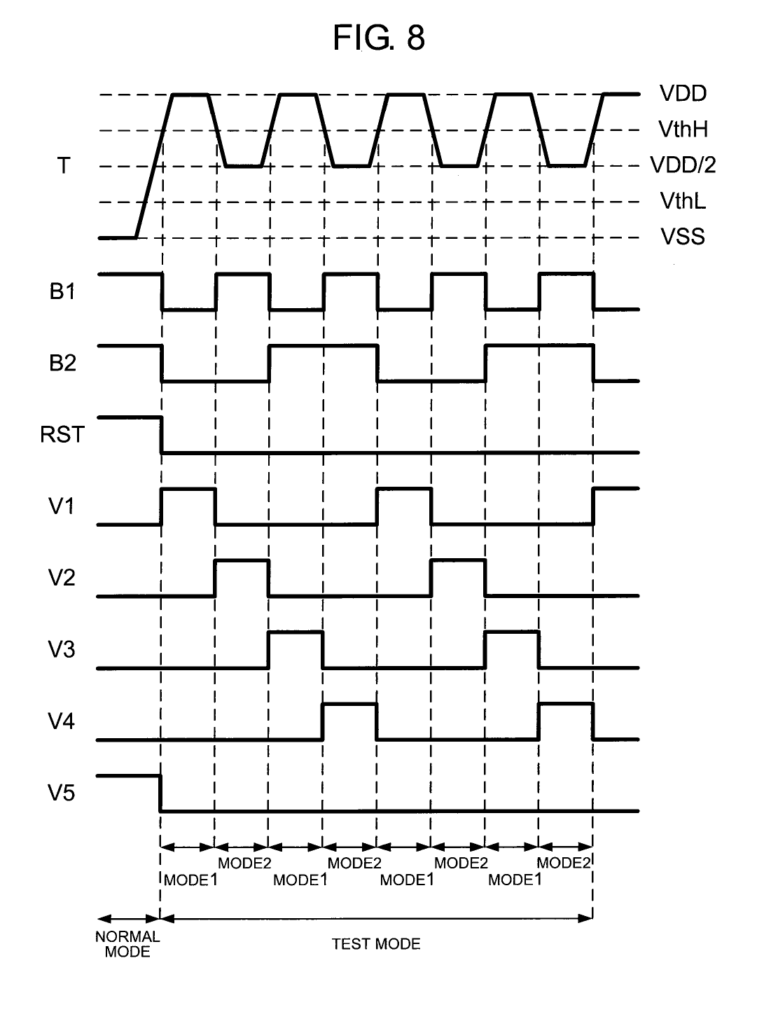

Next, an operation of the test mode setting circuit is described. FIG. 8 is a time chart illustrating voltages at respective nodes of the test mode setting circuit according to the fourth embodiment.

In the third embodiment, the timing when the reset signal RST falls is the timing when the test signal T becomes higher than the low threshold voltage VthL. In the fourth embodiment, however, the timing is the timing when the test signal T becomes higher than the high threshold voltage VthH. In other words, if the test signal T becomes higher than the high threshold voltage VthH, the reset signal RST falls and the semiconductor device shifts from the normal mode to the test mode.

On this occasion, if (reset signal RST)=(“1 ”), similarly to the third embodiment, the logic circuit 24 operates so that (signal V1, signal V2, signal V3, signal V4, signal V5)=(“0”, “0”, “0”, “0”, “1”) may be satisfied. Accordingly, the waveforms of the signals V1 to V5 are changed because of the change of the falling timing of the reset signal RST.

What is claimed is:

1. A test mode setting circuit for controlling a test mode of a semiconductor device, comprising:
a first detector having a first threshold voltage and including an input terminal connected to a test terminal;
a second detector having a second threshold voltage and including an input terminal connected to the test terminal; and
a logic circuit including a first input terminal connected to an output terminal of the first detector and a second input terminal connected to an output terminal of the second detector, for controlling the test mode of the semiconductor device based on output signals of the first detector and the second detector,
wherein a reset of the logic circuit is released when a voltage of the test terminal changes from a first power supply voltage to exceed the first threshold voltage of the first detector, to thereby set the semiconductor device to the test mode, and
wherein, in the test mode of the semiconductor device, when the voltage of the test terminal exceeds the second threshold voltage of the second detector, the logic circuit controls switching of a mode setting of the test mode.

2. A test mode setting circuit according to claim 1, further comprising a latch connected between the output terminal of the first detector and the first input terminal of the logic circuit,
wherein a reset of the latch is released when the voltage of the test terminal changes from the first power supply voltage to exceed the first threshold voltage of the first detector, and the latch is set when the voltage of the test terminal exceeds the second threshold voltage of the second detector, and thereby releases the reset of the logic circuit.

3. A test mode setting circuit for controlling a test mode of a semiconductor device, comprising:
a first detector having a first threshold voltage and including an input terminal connected to a test terminal;
a second detector having a second threshold voltage and including an input terminal connected to the test terminal;
a counter including a clock terminal connected to an output terminal of the second detector and a reset terminal connected to an output terminal of the first detector, for counting a signal input to the clock terminal; and
a logic circuit including a reset terminal connected to the output terminal of the first detector and an input terminal connected to an output terminal of the counter, for controlling the test mode of the semiconductor device based on output signals of the first detector and the counter,
wherein a reset of each of the counter and the logic circuit is released when a voltage of the test terminal changes from a first power supply voltage to exceed the first threshold voltage of the first detector, to thereby set the semiconductor device to the test mode, and
wherein in the test mode of the semiconductor device, the counter outputs a signal based on a signal output from the second detector, and the logic circuit controls switching of a mode setting of the test mode based on the signal output from the counter.

4. A test mode setting circuit according to claim 3, further comprising a latch connected between the output terminal of the first detector and the reset terminals of the counter and the logic circuit,
wherein a reset of the latch is released when the voltage of the test terminal changes from the first power supply voltage to exceed the first threshold voltage of the first detector, and the latch is set when the voltage of the test terminal exceeds the second threshold voltage of the second detector, and thereby releases the reset of the counter and the reset of the logic circuit.
